(19) United States
(12) Patent Application Publication
(10) Pub. No.: US 2006/0282495 A1
(43) Pub. Date: Dec. 14, 2006

(54) Method for providing information concerning broadcast contents for a user

(75) Inventors: Daniele Abbadessa, Heidelberg (DE); Telemaco Melia, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/447,965

(22) Filed: Jun. 7, 2006

(30) Foreign Application Priority Data
Jun. 8, 2005 (DE) 10 2005 026 539.1

(51) Int. Cl. G06F 15/16

(52) U.S. Cl. 709/202; 709/203

(57) ABSTRACT

A method for providing information concerning broadcast contents for a user is designed and further developed in such a way that the user sets preferences regarding the broadcast contents via the network, achieving the option of a systematic selection of program contents in an infrastructure that is at the same time as simple as possible. The user is connected to a network—a mobile radio network, Internet or the like —and can receive broadcast. From the broadcast contents one or more program lists representing the broadcast contents corresponding to the set preferences are generated by using the set user-specific preferences. On the base of the program lists status lists reflecting the current states and changes of state of the broadcast contents that are handed over together with the program lists are generated by a software program executed at the user.

### BACKGROUND OF THE INVENTION

1. Field of the Invention

The present invention relates a method for providing information concerning broadcast contents to a user wherein the user is connected to a network—a mobile radio network, Internet or the like—and can receive broadcast. The term “broadcast” refers in a broad sense to any type of audio and/or video broadcast sent over the air. The examples presented in this document refer mainly to TV broadcasting.

2. Description of the Related Art

When broadcasting TV, audio etc., it is often the case that together with the actual audio or video information additional information is provided. It has been known for a long time to display the name of the currently broadcasted piece of music or to provide information regarding future program content. In general, the network to which the user is connected and via which the user gets the additional information—for example with a laptop from the Internet or with a mobile from the mobile radio network—, and the broadcast network from whichbroadcastisreceivedaredifferentnetworks. Inspecific cases, these two networks can be identical, though, and to give an example, it should be referred to the Internet radio. In this case, audio information, such as for example music, news etc., and additional information, such as for example information referring to broadcast contents, are sent from one station over the Internet.

With the known methods of the above mentioned kind there is the problem that the broadcast receiver of the user has to be in a ready-to-receive mode, i.e. it must be turned on in order to be able to receive the above mentioned additional information. Moreover, the additional information refers in general only to the broadcast contents of the currently selected channel.

In case a user is interested in specific broadcast contents, he consequently has to turn on his broadcast receiver and has to search individual channels subsequently for corresponding contents. This search for interesting contents is very time-consuming, though, and makes the usage of broadcast unattractive for many kinds of users. Moreover, the continuous operation of the device during searching results in increased power consumption. Regarding the available battery lifetime of the devices, this is in particular critical in case of portable mobile devices with an integrated broadcast receiver, which in general are battery-driven, such as for example a handset with integrated DVB-H (Digital Video Broadcasting-Handheld) receiver.

### SUMMARY OF THE INVENTION

Hence, the present invention is based on the task to design and further develop a method of the above mentioned kind according to which the systematic selection of broadcast contents can be performed in the easiest and most user-friendly way possible, with low efforts from the user.

According to the invention, the task mentioned above is solved by the characteristics of claim 1. A method for providing information concerning broadcast contents for a user, wherein the user is connected to a network—a mobile radio network, Internet or the like—and can receive broadcast, wherein the user sets preferences regarding the broadcast contents via the network, wherein from the broadcast contents one or more program lists representing the broadcast contents corresponding to the set preferences are generated by using the set user-specific preferences, wherein on the base of the program lists status lists are generated and updated by a software program executed at the user, said status lists reflect the current states and changes in state of the broadcast contents contained in the program lists.

According to the invention, it has first been recognized that a user can be provided in an advantageous way with those broadcast contents that correspond to his individual interests by using a Presence technology. In other words, the method according to the invention provides the user with information about the broadcast contents relevant for him and by these means a systematic usage of broadcast services becomes possible. According to the invention, after the user has defined his preferences about the available broadcast contents, one or more program lists are generated accordingly. From these program lists one or more dynamic status lists are created and are always kept updated by a software program executed at the user—for example on a laptop, a handset or a mobile. These status lists convey information about the broadcast contents that satisfy the user preferences.

By doing so, the user gets information which indicates to him whether interesting contents, i.e. contents corresponding to his set preferences, are broadcasted. By doing so, time-consuming and cumbersome searching of broadcast channels for relevant contents can consequently be avoided efficiently, which will result in an increase of attractiveness of broadcast services. The method according to the invention offers in particular the additional advantage of saving energy when using battery-driven devices, because the broadcast receiver will only be turned on in those moments when it will be required for actually receiving currently broadcasted user-specific contents. After a short initialization phase, the status lists are available. Simultaneously, by generating and updating the dynamical status lists at the user, and with relatively low data amounts, the network-side infra-structure is reduced to a minimum.

“Presence technology” as employed in the method according to the invention, means a range of different applications and protocols which enable informing the user about changes of specific states. Just to give an example and regarding the specification of Presence technology known in practice, the IETF RFC 2778 “A Model of Presence and Instant Messaging”, M. Day, J. Rosenberg, H. Sugano, the IETF RFC 2779 “Instant Messaging/Presence Protocol Requirements”, M. Day, S. Aggarwal, G. Mohr, J. Vincent, the 3 GPP TS 23.141 v6.6.0 “Presence Service”, as well as the OMA “The Wireless Village initiative: System Architecture Model” v1.1, WV-020 should be mentioned and it should be pointed out that the method according to the invention is not bound to any specific Presence technology.

The employment of Presence technology according to the invention is especially advantageous, because this technology is already used for different communication services, such as for example voice calls, Instant Messaging etc. In this sense, Instant Messaging in the Internet is for example already widely used and has now started to gain increasing importance also within the mobile world. In case of Instant Messaging, the sender of a message is informed about the state of potential receivers by Presence technology. This message can be the information that the receiver is “online” and therefore ready to receive, or “offline” and hence not ready to receive. Other status indications as “I'm out”, “Please do not disturb” etc. are possible. Since the method according to the invention in this sense uses known technology, the method can easily be integrated into user devices_{[DA1]}. Finally, the employment of Presence technology is also advantageous regarding the support of an easy-to-use interface.

Regarding the broadcast technology it should be pointed out that the invention is not subject to any restrictions in this sense either. The method according to the invention can be implemented into all digital as well as analogue broadcast technologies wherein the employment for radio, TV, satellite, streaming over cellular network and IP networks, DAB (Digital Audio Broadcasting) and DVB (Digital Video Broadcasting) is in the focus.

In the context of a preferred embodiment it is provided that the states listed by the status lists refer to the broadcast activity (“On air+38/“Not on air”), the broadcasted content (news/sports/feature film/magazine/ . . .) and/or the physical broadcast channel. If necessary, other additional information can also be added to the status lists. The creation of status lists and the states listed therein require information about broadcast programs. This information can, for example, be provided directly by the broadcast provider or by any third party.

In an advantageous way it can be provided that the setting of user-side preferences is performed via a specific portal. In this sense, the user could for example access an Internet TV portal via his laptop and select contents corresponding to his interests from the TV broadcast offer available there. User preferences can be used to generate the TV program lists relevant to the specific user. In addition, the generated program lists can be presented to the user for further checking and approval.

Before forwarding the program lists to the user, the receiver of the lists should be registered to the portal. This is in particular of importance because the definition of user-specific preferences and the reception of broadcast contents can be performed by different devices of the user.

According to the invention, a software program executed at the user, which preferably carries out the function of an agent, is the receiver of the program lists. Based on this information, the agent generates status lists and updates these status lists in case of status changes. Regarding an especially universal employment, the software program can in addition be enabled to request status information about broadcast contents. By doing so, it can be secured that, for example, after a loss of connection the respectively current state is available to the software program.

Regarding an especially high user-friendliness, it can be provided that the user is informed actively about the current states and/or changes of state of the status lists according to his preferences. In other words, the user is always indicated the broadcast contents relevant for him, for example, the start of a broadcasting corresponding to one of his interests. In this way, a particularly efficient usage of offered broadcast services is possible.

Informing the user can be performed in an advantageous way by, for example, popup-windows, beeps or the like. According to the individual taste of the user the way of being informed can freely be chosen and set.

In a concrete embodiment every individual status list created by the software program can refer correspondingly to one individual broadcast channel. Such an implementation is beneficial in that case a user is not interested in specific programs or topics, but only in the contents of a specific broadcast channel.

Alternatively, the software program can create one or more status lists which individually refer to a user-specific profile. As user-specific profiles, in particular topic-based profiles, where the user chooses specific topics such as sports, travel reports, talk-shows etc., or time-based profiles are imaginable. In case of a purely time-based user profile, the user chooses from the broadcast channels available to him concrete broadcastings which are interesting for him. In this case, the creation of one single status list would be sufficient.

In order to visualize graphically, Presence buddies representing the status lists can be generated, which can be shown to the user on a displaying device, for example an LCD. The Presence buddies could be added to the Presence list of the user already created, for example, for Instant Messaging, in order to achieve a rather high level of clarity and easy usability, in particular for those users who are not yet familiar with the method. The Presence list can be shown to the user on a display as well, for example as a window that can be activated.

It is responsibility of the software program (the agent), which is executed at the user, to communicate status list changes related to broadcast contents to the “Presence” application executed at the user. These status changes are for example communicated in the form of “Presence status changes” messages, which will be specific to the specific “Presence” technology utilized.

Regarding a possibly easy invoking or receiving of broadcast contents matching the preferences of the user, it can be provided that by clicking on or selecting in any other way a Presence buddy in the Presence list, the corresponding broadcast reception can be activated. Depending on the concretely employed broadcast technology such an “on-click” tuning can be realized by having the corresponding radio frequency automatically selected from the status list and having the broadcast receiver tuned accordingly.

Now, there are several options of how to design and to further develop the teaching of the present invention in an advantageous way. For this purpose, it must be referred to the claims subordinate to claim 1 on the one hand and to the following explanation of a preferred example of an embodiment of the method according to the invention together with the figure on the other hand. In connection with the explanation of the preferred embodiment of the invention and the figure, generally preferred designs and further developments of the teaching will also be explained.

### BRIEF DESCRIPTION OF THE DRAWINGS

FIG. 1 is a diagram showing a first example of an embodiment of the method according to the invention in a schematic model;

FIG. 2 is a diagram showing a second example of an embodiment of the method according to the invention in a schematic model;

FIG. 3 is a schematic diagram showing the processes in case of an implementation of an example of an embodiment according to FIG. 2; and

FIG. 4 is a diagram showing in a schematic model the status lists generated for the user-specific preferences, as well as their usage when applying the method according to the invention.

### DESCRIPTION OF THE PREFERRED EMBODIMENTS

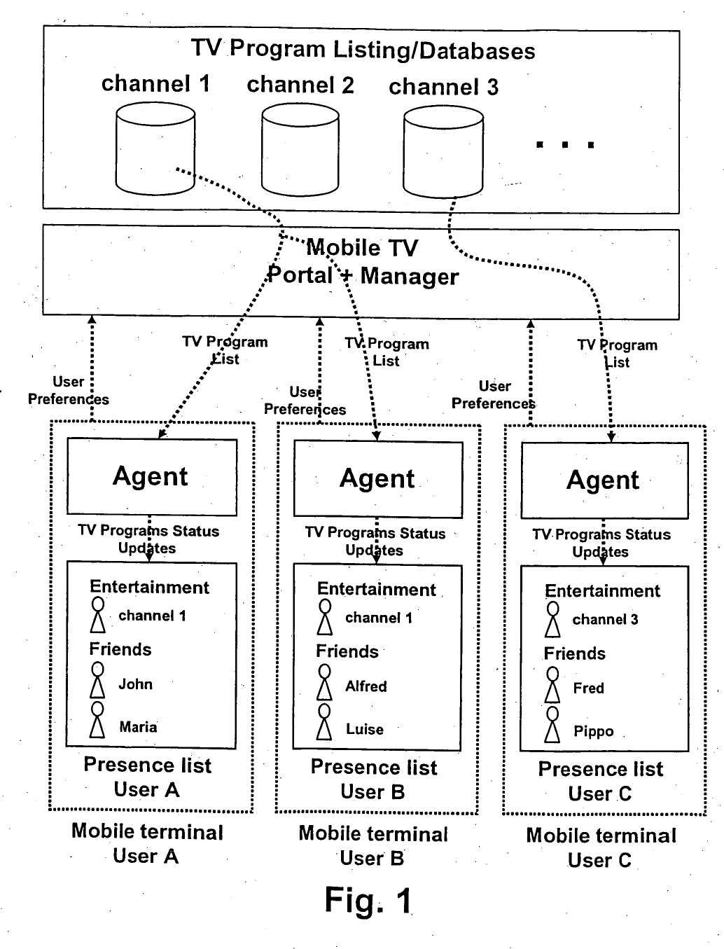

FIG. 1 shows schematically a model of a first example of an embodiment of a method according to the invention by which the users—user A, B and C—are provided with information about broadcast contents matching their respective preferences. The model shown reflects an approach where the users are not interested in specific programs or contents. Their interest is focused only on one or more broadcast channels which they have chosen for example via a corresponding portal. For selecting the broadcast channels as well as the actual broadcast reception, a user can use, for example, a handheld (PDA, mobile etc.) with an integrated DVB-H receiver. At the same time, it can also be envisioned that the selection is performed by an additional device, for example a laptop.

In the example of an embodiment shown in FIG. 1, the users A and B have set their preferences on channel 1, whereas user C has chosen channel 3. After having defined the user preferences, a software program, which in this example of an embodiment carries out the function of an agent and which is executed at the user, generates for every broadcast channel a status list, which is represented by a corresponding Presence buddy respectively. This Presence buddy is added to the Presence list of the corresponding user, which already contains entries of authorized communication partners for Instant Messaging (Friends).

After the creation of the Presence buddies, they are updated regularly by the agent. By doing so, the user receives continuous and current information on the currently broadcasted contents broadcasted on this channel.

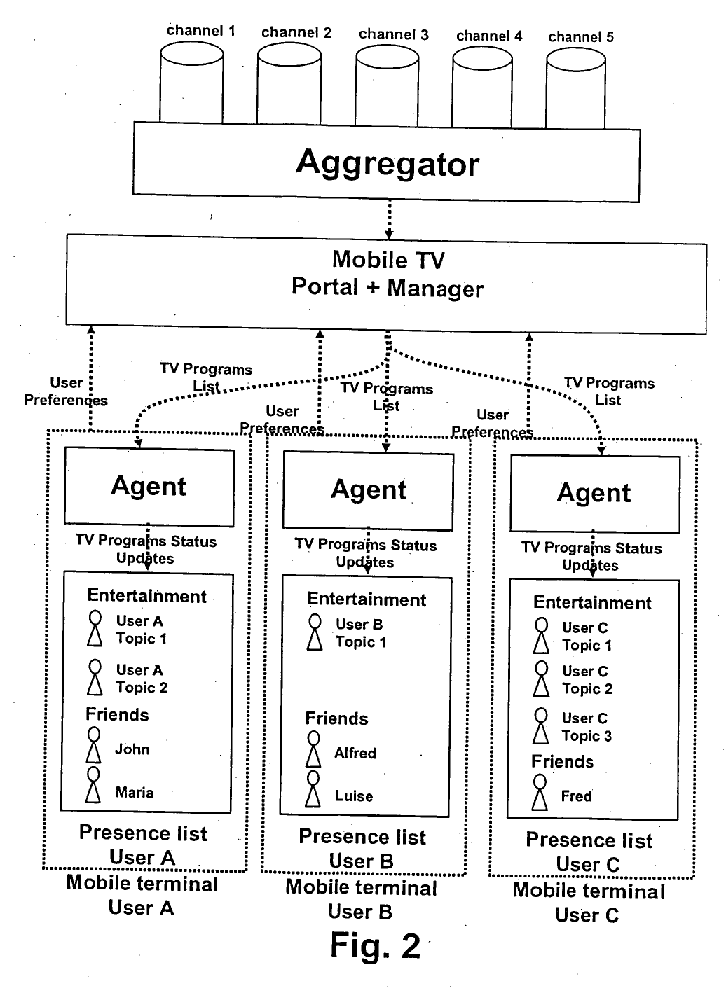

FIG. 2 also shows a schematic model of an example of an embodiment of a method according to the invention. The implementation is more complex than in the example of an embodiment described above and enables the users to set specific topics as preferences. The selection of the topics is, for example, again performed via a specific portal. User A has announced his interest in the topics 1 and 2, whereas user B only wants to be informed about topic 1 and user C is interested in the topics 1, 2 and 3. For each of the topics, a status list—again represented by corresponding Presence buddies—is created by a software program which is respectively executed at the user and which again carries out the function of an agent. The Presence buddies are integrated into the corresponding Presence lists of the users and are continuously updated by the corresponding agents. In this example of an embodiment, they get their information about broadcasted contents of the available broadcast channels—here channel 1 to channel 5 +13VIA an aggregator.

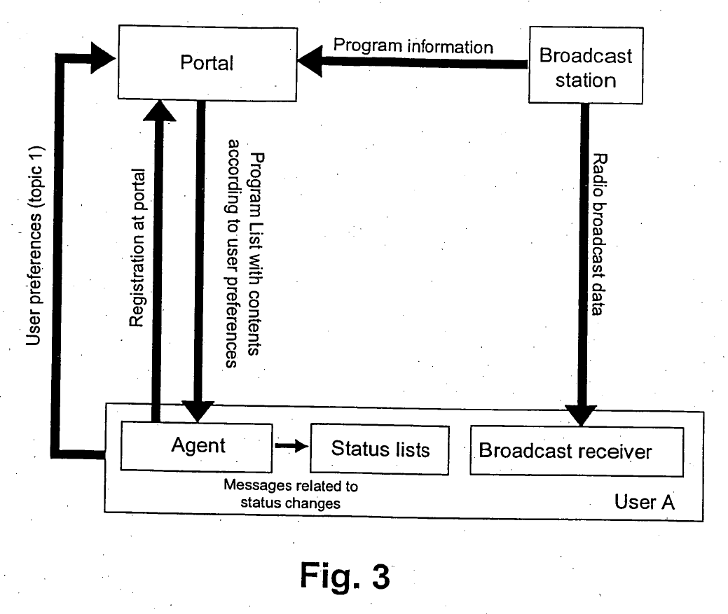

FIG. 3 shows schematically the individual logic building blocks and the data flows of an implementation according to the example of an embodiment depicted in FIG. 2. The processes for user A and topic 1 are depicted here as an example. For other combinations of user and topic, the processes apply mutatis mutandis.

At the portal, user A sets his preference for topic 1. The definition of the preferences and the broadcast reception are here performed by one single device, for example a PDA or a mobile with an integrated DVB-H receiver. The software program—the agent—running on the receiving device of the user will then be registered at the portal and will receive in the following the individual program lists. Based on this, the agent generates a status list.

Changes of the user selected broadcasted program contents will be announced to the agent and related updates of the status lists will be performed. The corresponding information about the broadcasted program contents is provided to the portal by the broadcast stations or a further service provider.

The agent generates not yet existing status lists and updates their state regularly. From these status lists, Presence buddies are created in the end and-automatically or manually-added to a Presence list of user A. The status lists generated by the agent will be based only on broadcast content which satisfies the user preferences and the user will be informed about the broadcasting of this content accordingly.

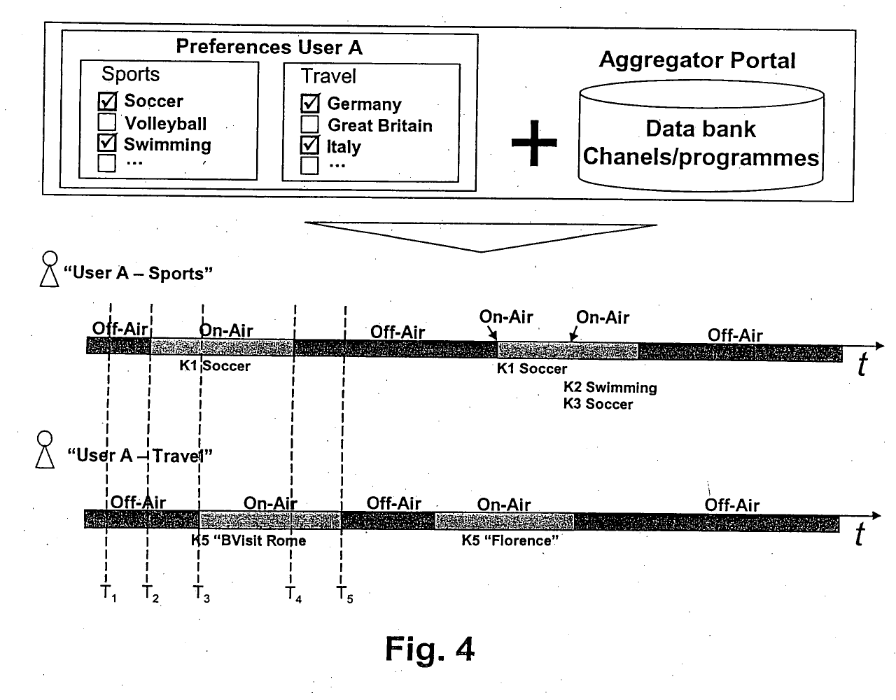

FIG. 4 depicts in a schematic overview the status lists generated for the user-specific preferences and their employment when applying the method according to the invention. User A has indicated that he is interested in the areas of “sports” and “travel”. In case of sport programs, he prefers the topics “soccer” and “swimming”, in case of travel programs he wants to be informed about the countries of “Germany” and “Italy”. For any of the superordinated areas of interest—“sports”, “travel”—a Presence buddy, whose status is depicted in FIG. 4 on a timeline, is created by the agent. The drawing indicates that at time T₁, there is no report broadcasted about any of the two topics (“off-air”). At time T₂, a report about soccer (“on air”) is started about which the user is informed correspondingly. At time T₃ the state in the second status list (“user A —travel”) switches from “off air2 to “on air”, because a broadcasting matching the preferences set by user A starts (“Visit—Rome”). The user can be informed about this as well and he can decide which of the two broadcastings he wants to continue with. At time T₄, the report about the topic of “soccer” ends, so therefore the state in the status list “user A —sports” changes to “off air”. At time T₅, the same happens for the status list “user A —travel”.

If the user decides for the reception of a broadcast content matching one of his preferences, the broadcaster receiver on the user terminal is automatically switched on and tuned on the correct radio frequency. In the example depicted above, for the soccer report starting at time T₂, channel 1 would have to be chosen.

Finally, it is particularly important to point out that the completely arbitrarily chosen examples of an embodiment of the teaching according to the invention from above only serve as illustration of the teaching as according to the invention, but that they do by no means restrict the latter to the given examples of an embodiment.

1. A method for providing information concerning broadcast contents for a user, wherein the user is connected to a network—a mobile radio network, Internet or the like—and can receive broadcast, wherein the user sets preferences regarding the broadcast contents via the network, wherein from the broadcast contents one or more program lists representing the broadcast contents corresponding to the set preferences are generated by using the set user-specific preferences, wherein on the base of the program lists status lists are generated and updated by a software program executed at the user, said status lists reflect the current states and changes in state of the broadcast contents contained in the program lists.

2. The method according to claim 1 wherein the states listed in the status list refer to the broadcast activity, the broadcasted content and/or the physical broadcast channel and/or additional information.

3. The method according to claim 1 wherein the user sets his preferences via a specific portal.

4. The method according to claim 1 wherein the software program executed at the user carries out the function of an agent.

5. The method according to claim 1 wherein the software program executed at the user receives and/or requests information including the program lists and/or additional information corresponding to the set preferences.

6. The method according to claim 1 wherein the user is informed about the current states and/or changes of state of the status lists corresponding to his preferences.

7. The method according to claim 1 wherein the user's attention is drawn to changes of state by pop-up windows, signaling beeps or the like.

8. The method according to claim 1 wherein the generated status lists refer to an individual broadcast channel in each of the generated status lists.

9. The method according to claim 1 where in the generated status lists refer to a user-specific profile respectively.

10. The method according to claim 9 wherein the user-specific profile is based on topics or time.

11. The method according to claim 1 wherein Presence buddies are created in order to visualize graphically the status lists and represent them.

12. The method according to claim1 where in the Presence buddies are added to a Presence list of the user.

13. The method according to claim 11 wherein the user can initiate user's desired actions by clicking on Presence buddies in his Presence list.

14. The method according to claim 13 wherein the user's desired actions include activating the reception of broadcast contents according to his preferences and/or getting information about the current broadcast content.

15. The method according to claim 4 wherein the software program executed at the user communicates with the Presence list of the user
